(19) United States
(12) Patent Application Publication
(10) Pub. No.: US 2006/0245006 A1
(43) Pub. Date: Nov. 2, 2006

(54) Image processor, control method thereof and computer program product

(75) Inventors: Hironobu Nakata, Itami-shi (JP); Masakazu Murakami, Itami-shi (JP); Kazumi Sawayanagi, Itami-shi (JP); Minako Kobayashi, Ikeda-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Tokyo (JP)

(21) Appl. No.: 11/225,121

(22) Filed: Sep. 14, 2005

(30) Foreign Application Priority Data
May 2, 2005 (JP) 2005-134608

(51) Int. Cl. H04N 1/23

(52) U.S. Cl. 358/448; 358/296

(57) ABSTRACT

An image forming device is provided with a job history memory portion for storing job history information that indicates process contents of image processing every time when the image processing is performed, a next process predicting portion for performing prediction of process contents of image processing that is probably designated by a user next after the image processing of process contents designated by the user was performed in accordance with job history information stored in the job history memory portion, and a screen setting portion for performing a display process for displaying a screen on which process contents of the predicted image processing is set.

This application is based on Japanese Patent Application No. 2005-134608 filed on May 2, 2005, the contents of which are hereby incorporated by reference.

### BACKGROUND OF THE INVENTION

1. Field of the Invention

The present invention relates to an image processing device such as an MFP for performing various types of image-related processes about an image and a method for controlling the image processing device.

2. Description of the Prior Art

In recent years image processing devices having functions of a copying machine, a network printer, a scanner, a fax machine, a document server and the like have become commonplace. Such an image processing device is called a multifunction device or multi function peripherals (MFP). The function as a document server assigns a storage area of a hard disk drive to each of users and enables each user to store data such as an image file in his or her storage area. The storage area may be called a “box” or a “personal box”.

Along with increase of performance of image processing devices, it has been possible for users to use the image processing devices in order to perform various types of processes.

However, since the number of operation screens increases along with high performance of image processing devices, operation of image processing devices has become difficult for users. Since the number of operation steps has increased, even a user having expert knowledge may need much time and effort for performing an operation for setting a desired process.

Therefore, it is considered to adopt a method disclosed in Japanese unexamined patent publication No. 2004-72563. According to this method, the number of jobs used by a user during a predetermined period is searched from a past job list, and a screen of an operation mode of a job having the maximum number of usage times is displayed. Alternatively, a job list of an operation mode of a job having the latest date is generated and displayed. For example, if the operation mode that was performed last is a scanner mode, it is predicted that the user desires information about the scanner mode. Therefore, a job list of the scanner mode is displayed. According to this structure, time and effort for switching screens can be reduced so that ease of operation can be improved.

However, according to this conventional method, when the image processing device has many functions and the number of types of practicable processes increases, probability of matching between a user's desired process and a screen display decreases. In other words, it becomes difficult to realize a user interface that is easy for users to use.

### SUMMARY OF THE INVENTION

An object of the present invention is to provide a user interface that is easy for users to use in an image processing device that can perform various types of processes.

An image processing device according to the present invention is an image processing device for performing an image-related process about an image. The image processing device includes a next process predicting portion for performing prediction of process contents of the image-related process that is probably designated by a user next after the image-related process of contents designated by the user was performed, and a display processing portion for performing a display process for displaying a screen on which process contents of the predicted image-related process is set.

According to the present invention, contents of a process that is probably designated by the user next is predicted in accordance with the user's past usage pattern, and a process for displaying a screen in which contents of the predicted process is set. Therefore, a user interface that is easy for users to use can be provided in an image processing device that can perform various types of processes.

### BRIEF DESCRIPTION OF THE DRAWINGS

FIG. 1 is a diagram showing an example of a general structure of a system equipped with an image forming device.

FIG. 2 is a diagram showing an example of a hardware structure of the image forming device.

FIG. 3 is a diagram showing an example of a structure of an operation panel.

FIG. 4 is a diagram showing an example of a functional structure of the image forming device.

FIG. 5 is a diagram showing an example of a user information table.

FIG. 6 is a diagram showing an example of a log in screen.

FIG. 7 is a diagram showing an example of a menu screen.

FIG. 8 is a diagram showing an example of a job history table.

FIGS. 9(a) and 9(b) are flowcharts showing an example of a flow of a next job prediction process.

FIG. 10 is a diagram showing an example of a job history table.

FIG. 11 is a diagram showing an example of a menu screen.

FIG. 12 is a diagram showing an example of a menu screen.

FIG. 13 is a flowchart showing an example of a flow of a general process of the image forming device in a first embodiment.

FIG. 14 is a flowchart showing an example of a flow of a general process of the image forming device in a second embodiment.

FIG. 15 is a flowchart showing an example of a flow of a next job prediction process.

FIG. 16 is a diagram showing an example of a search result list of job history information.

FIG. 17 is a diagram showing an example of a next job frequency table.

FIGS. 18(a)-18(c) are flowcharts showing an example of a flow of a next job candidate selection process.

### DESCRIPTION OF THE PREFERRED EMBODIMENTS

Hereinafter, the present invention will be explained more in detail with reference to embodiments and drawings.

### First Embodiment

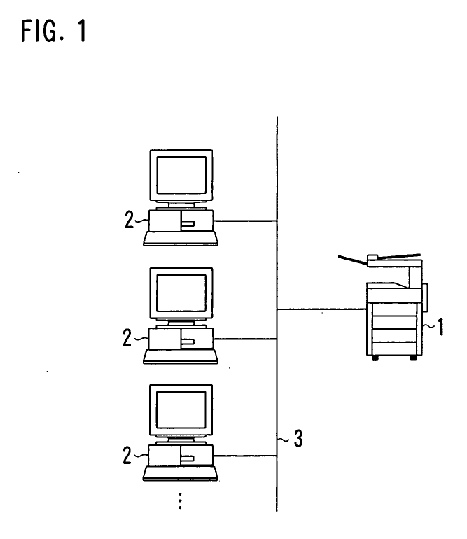

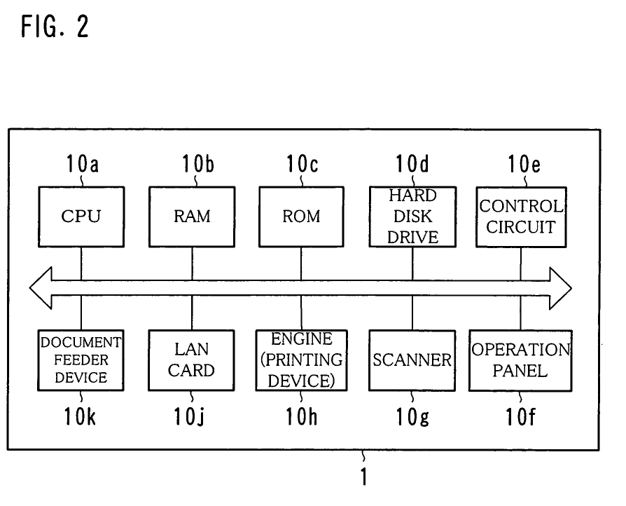

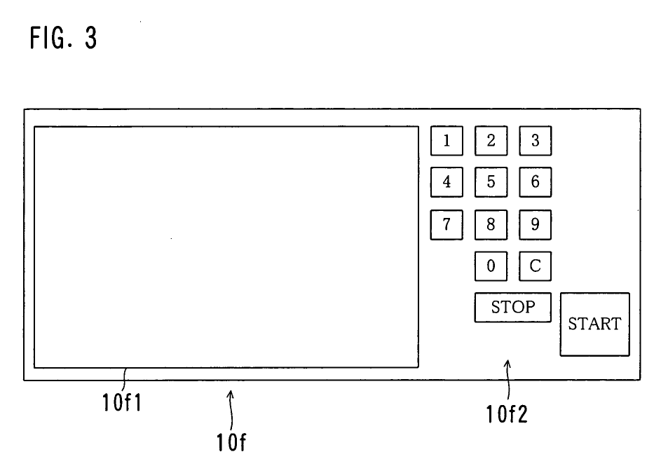

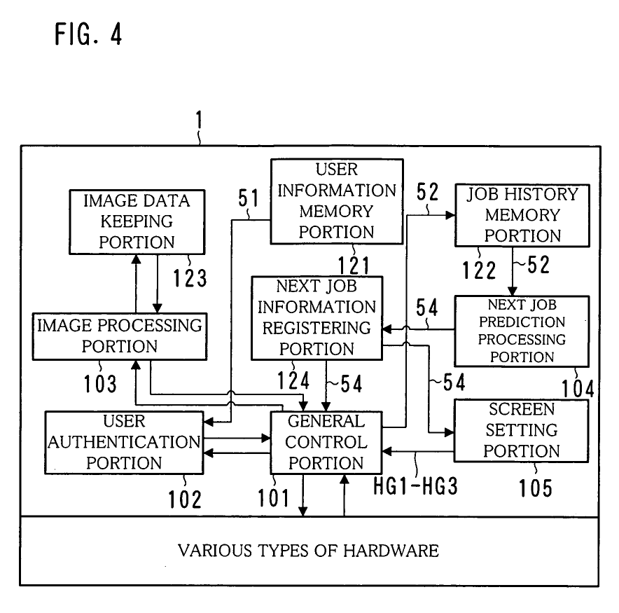

FIG. 1 is a diagram showing an example of a general structure of a system equipped with an image forming device 1, FIG. 2 is a diagram showing an example of a hardware structure of the image forming device 1, FIG. 3 is a diagram showing an example of a structure of an operation panel 10f, FIG. 4 is a diagram showing an example of a functional structure of the image forming device 1.

The image forming device 1 according to the present invention is connected to a plurality of terminal devices 2 via a communication line 3 as shown in FIG. 1. As the communication line 3, the Internet, a LAN, a public line, or a private line can be used, for example.

The image forming device 1 and the terminal devices 2 are installed in a facility such as an office or a school. Plural employees, teachers, or students (hereinafter referred to as “users” simply) share the image forming device 1 and the terminal devices 2.

The image forming device 1 is an image processing device having integrated functions of a copying machine, a scanner, a fax machine, a network printer, a document server and the like. This is also called a multifunction device or multi function peripherals (MFP).

According to a function of the document server, a storage area called a “box” or a “personal box” corresponding to a folder or a directory in a personal computer is assigned to each user. The user can store document data such as an image file in his or her box. This function may be called a “box function”.

As shown in FIG. 2, the image forming device 1 includes a CPU 10a, a RAM 10b, a ROM 10c, a hard disk drive 10d, a control circuit 10e, an operation panel 10f, a scanner 10g, a printing device 10h, a LAN card 10j, and a document feeder device 10k.

The scanner 10g is a device for optically reading an image including photographs, characters, pictures and charts on a sheet of an original (hereinafter sometimes referred to as an “original” simply) and producing image data. The document feeder device 10k is a device for feeding one or more set original sequentially to the scanner 10g.

The printing device 10h is a device for printing an image on paper in accordance with an image read by the scanner 10g or image data sent from the terminal device 2 or the like responding to designation by a user.

The operation panel 10f is made up of a display 10f1 and an operation button unit 10f2 including plural operation buttons as shown in FIG. 3.

The operation button unit 10f2 is made up of plural keys for entering numbers, characters or signs, a sensor for recognizing a pressed key, and a transmission circuit for transmitting a signal indicating a recognized key to the CPU 10a.

The display 10f1 displays a screen for giving a message or an instruction to a user who operates this image forming device 1, a screen for the user to enter a job type and a process condition, and a screen for showing an image formed by the image forming device 1 and a process result. In this embodiment, a touch panel is used for the display 10f1. Therefore, the display 10f1 has a function of detecting a position on the touch panel where a user touches with a finger, and a function of sending a signal indicating a detection result to the CPU 10a.

As described above, the operation panel 10f plays a role as a user interface for a user who operates the image forming device 1 directly. Note that an application program and a driver for instructing the image forming device 1 are installed in the terminal device 2. Therefore, the user can also use the terminal device 2 as a host computer for controlling the image forming device 1 and operate the image forming device 1 from a remote location.

The LAN card 10j shown in FIG. 2 is a network interface card (NIC) for performing communication with the terminal device 2.

The control circuit 10e is a circuit for controlling devices including the hard disk drive 10d, the scanner 10g, the printing device 10h, the LAN card 10j, the operation panel 10f and the document feeder device 10k.

The hard disk drive 10d stores programs, data and the like for realizing functions including a general control portion 101, a user authentication portion 102, an image processing portion 103, a next job prediction processing portion 104, a screen setting portion 105, a user information memory portion 121, a job history memory portion 122, an image data keeping portion 123, and a next job information registering portion 124 as shown in FIG. 4. The programs are executed by the CPU 10a. A part or a whole of the programs or the data may be stored in the ROM 10c. Alternatively, it is possible to design to realize a part or a whole of the functions shown in FIG. 4 by the control circuit 10e.

An application program and a driver corresponding to the image forming device 1 are installed in the terminal device 2 as described above. As the terminal device 2, a personal computer, a workstation or a personal digital assistant (PDA) can be used.

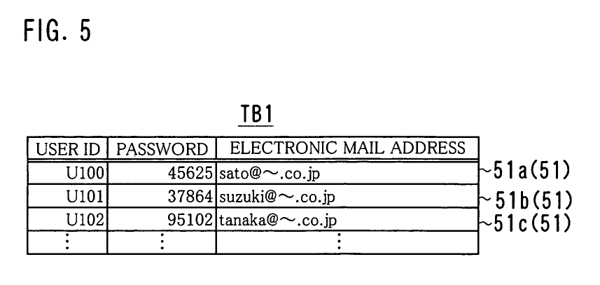

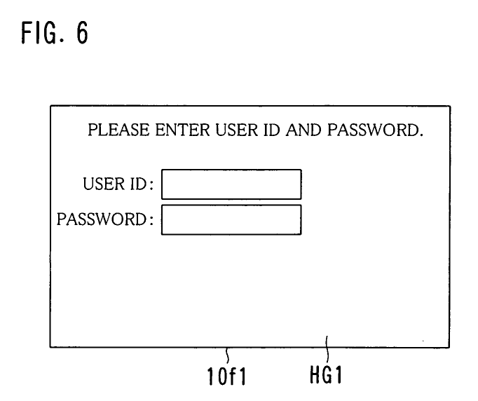

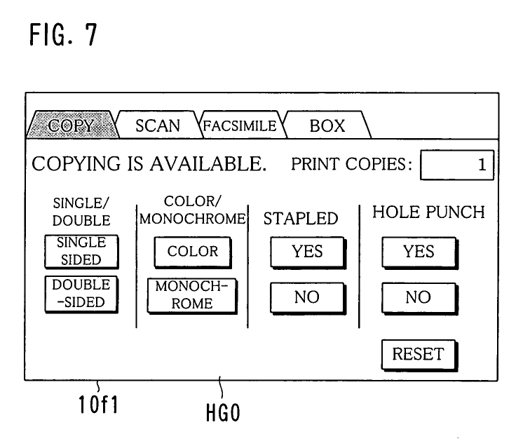

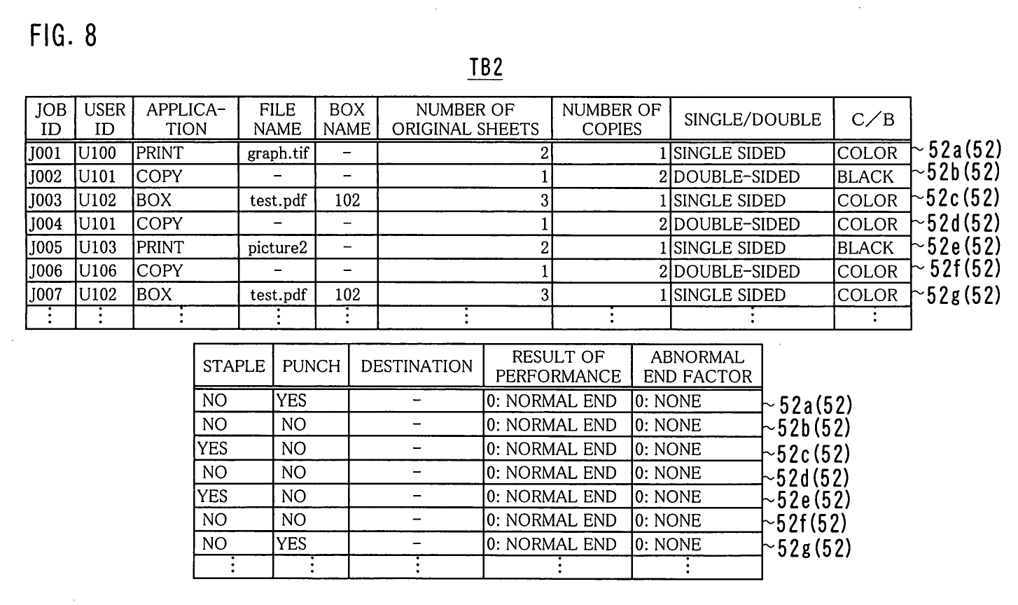

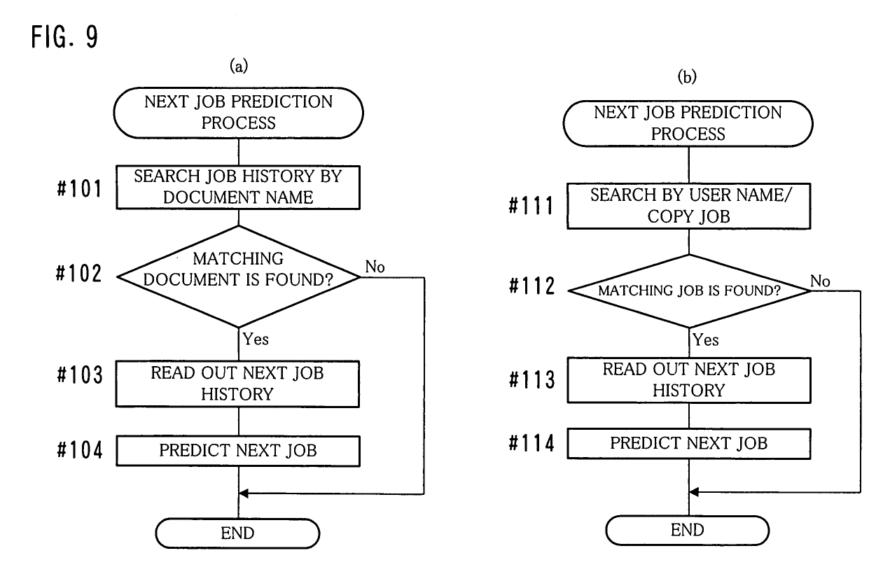

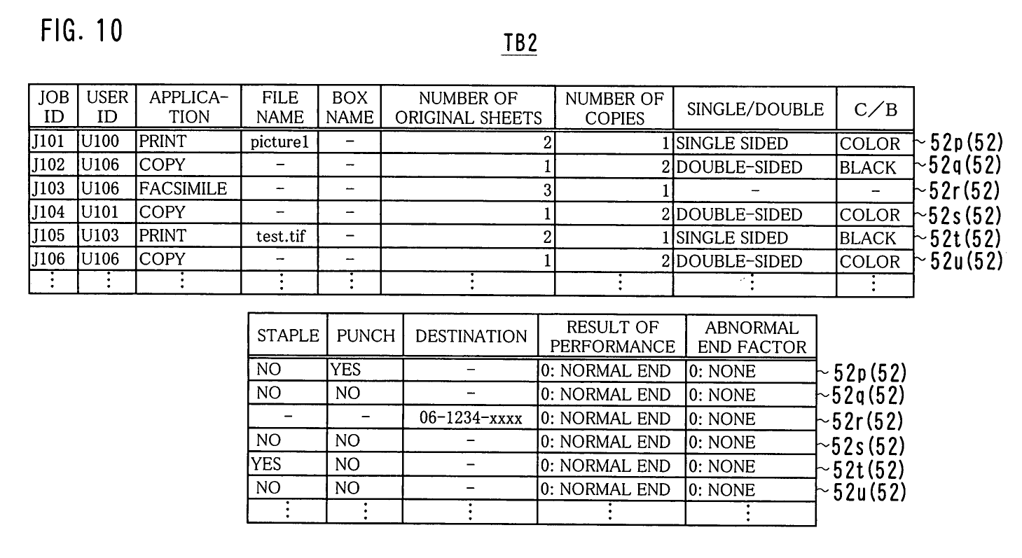

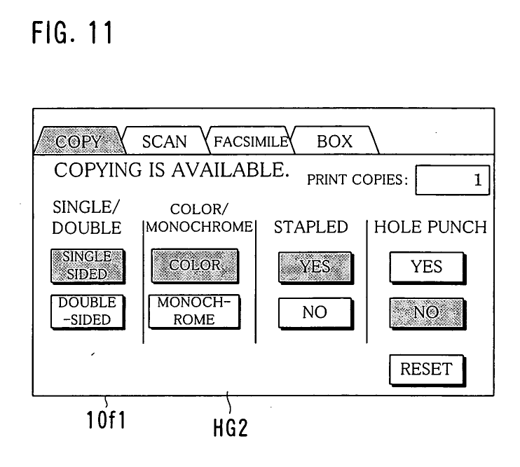

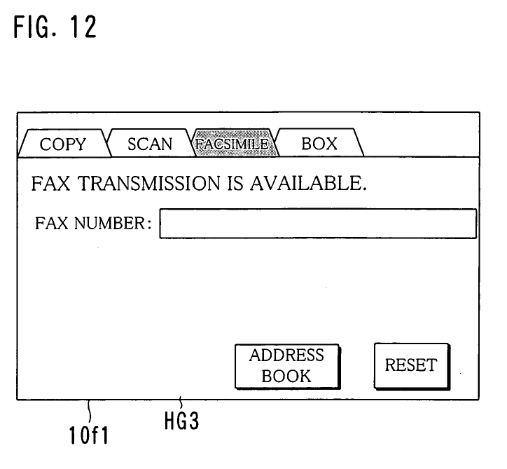

FIG. 5 is a diagram showing an example of a user information table TB1, FIG. 6 is a diagram showing an example of a log in screen HG1, FIG. 7 is a diagram showing an example of a menu screen HG0, FIG. 8 is a diagram showing an example of a job history table TB2, FIGS. 9(a) and 9(b) are flowcharts showing an example of a flow of a next job prediction process, FIG. 10 is a diagram showing an example of a job history table TB2, FIG. 11 is a diagram showing an example of a menu screen HG2, and FIG. 12 is a diagram showing an example of a menu screen HG3. Hereinafter, process contents of each portion of the image forming device 1 shown in FIG. 4 will be described.

The general control portion 101 shown in FIG. 4 controls the entire of the image forming device 1 so that basic processes are performed. For example, it performs the control so that a predetermined screen is displayed at a predetermined timing, and that an operation performed by the user is accepted, and that a job such as scanning, printing or data transmission is performed in accordance with the operation.

The user information memory portion 121 stores and manages the user information table TB1. This user information table TB1 stores user information 51 (51a, 51b, . . . ) including user IDs (user accounts), passwords and electronic mail addresses for communication of users who can use the image forming device 1 as shown in FIG. 5.

The user authentication portion 102 performs an authentication whether a person who is going to use the image forming device 1 is an authorized user or not. This authentication is performed in the following procedure. When nobody uses the image forming device 1 directly, the log in screen HG1 as shown in FIG. 6 is displayed on the display 10f1. A user who wants to use the image forming device 1 operates the operation button unit 10f2 so as to enter his or her user ID and password. Then, the general control portion 101 accepts the user ID and password, and it instructs the user authentication portion 102 to perform the process of the user authentication.

The user authentication portion 102 extracts the user information 51 that has a user ID of the same value as the entered user ID from the user information table TB1 shown in FIG. 5. Then, it compares the entered password with the password indicated in the user information 51, so as to authenticate that the user is an authorized user if the comparison result indicates that both the passwords are identical with each other. If the comparison result indicates that they are not identical, the user is decided to be an unauthorized user. If the user information table TB1 does not include the user information 51 having a user ID having the same value as the entered user ID, the person is also decided to be an unauthorized user. The person who was decided to be an unauthorized user cannot use the image forming device 1.

The user who received the authentication to be an authorized user is allowed to use the image forming device 1. In other words, the user can log in the image forming device 1. Then, the general control portion 101 displays a menu screen HG0 as shown in FIG. 7 on the display 10f1. Here, the user can perform a predetermined operation so as to instruct the image forming device 1 to perform a desired process. For example, if the user wants to perform a copying process, the user selects single-sided copy or double-sided copy, and color copy or monochrome (black) copy, and also designates finishing option and the number of copies of a printed matter in the state shown in FIG. 7. Then, the user presses a “START” button of the operation button unit 10f2 (see FIG. 3).

In the menu screen HG0 and other screens that will be described later, a button or a tab whose background is gray color indicates that it is selected at present. The user can change a process condition by pressing a button or can switch screens by pressing a tab.

If the user wants a process of scan, fax or box, the user may press a “scan” tab, a “fax” tab or a “box” tab, respectively, so as to switch screens, and may operate a button for designating a process condition, and then presses the “START” button.

When the user uses the image forming device 1 from a remote location via the terminal device 2, the user enters his or her user ID and password by operating a keyboard or the like of the terminal device 2. Then the user authentication portion 102 performs the process of user authentication in accordance with the user information table TB1 in the same manner as the case where the user enters his or her user ID and password by operating the operation button unit 10f2. Then, screen data for displaying a screen for designating execution of a process are transmitted from the image forming device 1 to the terminal device 2, so that the terminal device 2 displays the screen.

The image processing portion 103 performs image processing such as a process of digitizing an image read by the scanner 10g, a process of format transformation of image data or a process of enlarging or reducing an image. The image data keeping portion 123 stores temporarily image data of an image to be processed.

The job history memory portion 122 stores and manages the job history table TB2. The job history table TB2 includes job history information 52 (52a, 52b, . . . ) that indicates performance contents of each performed job as shown in FIG. 8. In other words, new job history information 52 of a job is generated and is stored in the job history table TB2 every time when the job is performed. Note that the job history information 52 is shown with being divided into two parts for a convenience of paper space in FIG. 8 and FIG. 10 that will be shown later.

A “job ID” of the job history information 52 is identification information for discriminating the job from other jobs. A “user ID” is a user ID of the user who made the instruction of the job.

An “application” means a type of the job. For example, a “print” means a printing (network printing or PC printing) job that was performed in accordance with image data that were sent from the terminal device 2. A “copy” means a copying job of an original that is set on the document feeder device 10k. A “box” means a printing (box printing) job that was performed in accordance with an image file stored in the box. A “fax” means a job of sending fax data to a fax terminal. A “scan” means a job of scanning and reading an image of an original and sending image data of the image to the terminal device 2 designated by the user by a protocol such as a file transfer protocol (FTP) or an electronic mail. Hereinafter, these jobs may be referred to with a type name (application name) like a “print job” or a “copy job”, for example. In addition, since the file stored in the box includes data of an image or a document to be printed, the file may be referred to as a “document”.

A “file name” indicates a name (document name) for identifying the file (image data or a document) that was used when the box job was performed. A “box name” indicates a name for identifying the box that is a storage place of the file.

A “destination” indicates a telephone number of a destination of transmission of fax data when the fax job is performed or a destination of transmission of image data when the scan job is performed.

The “number of original sheets”, the “number of copies”, a “single-sided/double-sided”, a “C/B”, a “staple”, and a “punch” respectively indicate the number of original sheets (the number of pages), the number of copies, the single-sided print or the double-sided print, the color print or the black (monochrome) print, with the staple finish or without the same, and with a punching finish or without the same, when the print job or the copy job is performed.

A “result of performance” indicates whether the job is performed normally or not. The “0: normal end” means that the job is performed normally, while the “1: abnormal end” means that the job ended abnormally when an error was generated. An “abnormal end factor” indicates a factor of the abnormal end.

With reference to FIG. 4 again, the next job prediction processing portion 104 performs a job in accordance with a designation by the user and then predicts a type or the like of the job that is predicted to be the next job that the user wants to perform. Hereinafter, the executed job is referred to as an “execution job”, and a job that is predicted to be the next job that the user wants to perform is referred to as a “next job”. Such a prediction is performed in the procedure like the flowchart shown in FIGS. 9(a) and 9(b) for example as follows in accordance with a type of the execution job and job history information 52 that is stored in the job history table TB2.

If a type of the execution job is the box job, the next job prediction processing portion 104 predicts the next job in the procedure shown in FIG. 9(a). More specifically, the job history information 52 that indicates a file name of the file that was used when the box job was performed is searched from the job history table TB2 (#101). If the job history information 52 is found (Yes in #102), job history information 52 just after the job history information 52 is read out (#103). Then, a type (an application) of the job indicated in the read job history information 52 is predicted to be the type of the next job (#104). In this case, it is possible to predict process conditions of the next job too in accordance with the information such as “one side/two sides”, “C/B”, “staple” or “punch” in the job history information 52.

For example, if the job history information 52g of the execution job is registered in the job history table TB2 as shown in FIG. 8, the next job prediction processing portion 104 searches the file name indicated in this job history information 52g, i.e., the job history information 52 indicating “test.pdf”. As a result, the job history information 52c is obtained. Then, the next job prediction processing portion 104 reads job history information 52 just after this job history information 52c, i.e., the job history information 52d, and it predicts that a type of the next job is the copy job in accordance with this job history information 52d. In addition, it is predicted that process conditions of the next job are “one-side printing”, “color printing”, “with stapling”, “without punch hole”.

Note that it is possible to include not only the file name but also a user ID or a box name in the search conditions so as to search more correctly the job history information 52 in which the same file was used in the step #101. In other words, it is possible to search the job history information 52 that indicates a file name of the file that was used in the execution job, a box name of a storage location for the file and a user ID of the user who designated the execution job.

Alternatively, if a type of the execution job is the copy job, the next job prediction processing portion 104 predicts the next job in the procedure shown in FIG. 9(b). More specifically, it searches the job history information 52 indicating a user ID of the user who issued an instruction of the execution job and indicating that it's the copy job from the job history table TB2 (#111). When the job history information 52 is found (Yes in #112), job history information 52 just after the job history information 52 is read out (#113). Then, it predicts that a type of the job indicated in the read job history information 52 is the type of the next job (#114). On this occasion, it is possible to predict also process conditions of the next job in accordance with information such as “one side/two sides”, “C/B”, “staple” or “punch” in the same way as the case of FIG. 9(a).

For example, if job history information 52u of the execution job is registered in the job history table TB2 as shown in FIG. 10, the next job prediction processing portion 104 searches the job history information 52 that contains the user ID “U106” that is the same as the user ID-of this job history information 52u and indicates that it's the “copy job”. As a result, job history information 52q is obtained. Then, the next job prediction processing portion 104 reads out job history information 52r just after this job history information 52q and predicts that a type of the next job is the fax job based on the job history information 52r.

If a type of the execution job is other than the box job or the copy job, the next job is predicted in accordance with its characteristic in the same manner.

With reference to FIG. 4 again, the next job information registering portion 124 stores the next job information 54 indicating the type of the next job predicted by the next job prediction processing portion 104 and the process condition in association with the user ID of the user who made the instruction of the execution job.

The screen setting portion 105 performs setting of the screen so that the user can easily designate a job of the type and the process conditions indicated in the next job information 54. For example, if the next job information 54 indicates that a type of the next job is the “copy job” and that the process conditions are “one-side printing”, “color printing”, “with stapling” and “without punch hole”, the menu screen HG2 is set, in which these process conditions are selected as default conditions as shown in FIG. 11. Alternatively, if the next job information 54 indicates that a type of the next job is the “fax job”, the menu screen HG3 as shown in FIG. 12 is set. These set menu screens are displayed on the display 10f1 by the general control portion 101. However, if the user logged in from the terminal device 2, screen data for displaying the screen are sent to the terminal device 2. The terminal device 2 displays the menu screen on the display of the terminal device 2 itself in accordance with the screen data sent from the image forming device 1.

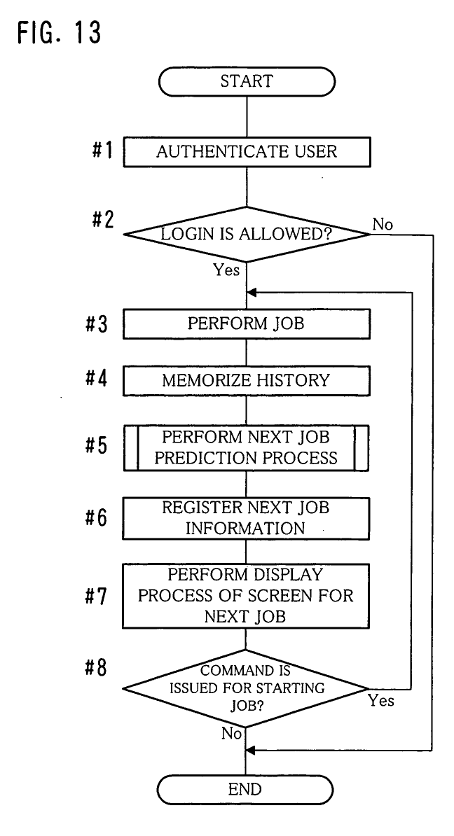

FIG. 13 is a flowchart showing an example of a flow of a general process of the image forming device 1 in the first embodiment. Next, a flow of the process of the image forming device 1 when the job is performed in accordance with the user's instruction will be described with reference to the flowchart shown in FIG. 13.

The image forming device 1 performs the user authentication in accordance with the user ID and the password entered by the user (#1). If the user is an authorized user, the user is allowed to log in the image forming device 1 (Yes in #2) and can instruct the image forming device 1 to perform a desired job.

When the image forming device 1 performs the job in accordance with the user's instruction (#3), job history information 52 concerning the process contents of the job (a type and process conditions) is registered in the job history table TB2 (#4).

A type and the like of the job that the user wants to perform next (the next job) are predicted in accordance with the type of the job that was executed this time (the execution job) and the job history information 52 that is already registered (stored) in the job history table TB2 (#5). The prediction processes are different from each other corresponding to types of the execution job this time as described above with reference to FIG. 9. For example, if the execution job this time is the box job, the process is performed in the procedure shown in FIG. 9(a). Alternatively, if it is the copy job, the process is performed in the procedure shown in FIG. 9(b). Thus, the next job information 54 is obtained. The obtained next job information 54 is registered in the next job information registering portion 124 in association with the user ID of the user. However, if the next job information 54 that is associated with the user ID is already registered, the old next job information 54 is deleted and the newly obtained next job information 54 is registered.

The screen setting is performed in accordance with the prediction result, i.e., the next job information 54, and the screen as shown in FIG. 11 or 12 is displayed (#7). Although a screen is displayed on the display 10f1 if the user is a local user who logged in by operating the operation panel 10f of the image forming device 1, the screen is displayed by sending screen data to the terminal device 2 if the user is a network user who logged in by operating the terminal device 2.

Here, the user presses the “START” button of the operation button unit 10f2 if the user wants to perform the job under the conditions as shown on the screen. Thus, the instruction for performing the process is given to the image forming device 1. It is possible to press the “START” button after changing the process conditions to desired conditions by pressing a button on the screen if necessary.

After that (Yes in #8), the image forming device 1 performs a new job in accordance with the designated contents on the screen (#3). Hereinafter, processes of registering the job history information 52 and predicting the next job are performed until the user finishes using the image forming device 1 and logs off.

Note that if the user operates the terminal device 2 for the instruction, information indicating the instruction contents is transmitted from the terminal device 2 to the image forming device 1. The image forming device 1 performs the job in accordance with the information in the step #3.

According to this embodiment, a job desired by the user next is predicted in accordance with a past usage pattern of the user so that a screen corresponding to the prediction result is displayed. Therefore, the user can reduce a screen switching operation for performing the next job and an input operation of the process contents. Thus, a user interface that is easy for users to use can be provided. This display function is convenient for the following case.

It is convenient because a screen switching operation and an input operation of the process contents that are necessary for each process can be reduced for a user who often performs a sequential workflow including different jobs like [Step 1-1] the image forming device 1 prints out a document created by the terminal device 2 or stored in a box (network printing or PC printing), and [Step 1-2] a paper of the printed document is sealed and the image forming device 1 transmits the document to another fax terminal, for example.

### Second Embodiment

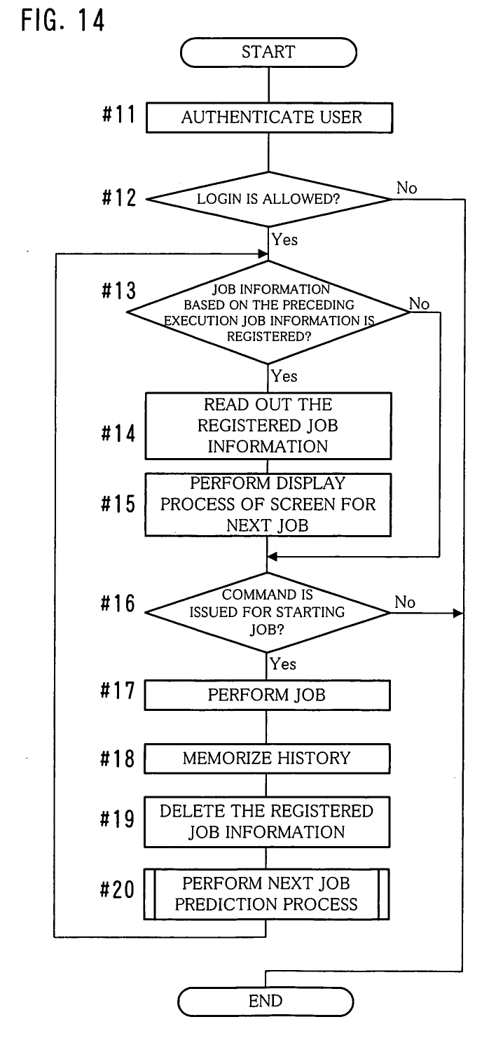

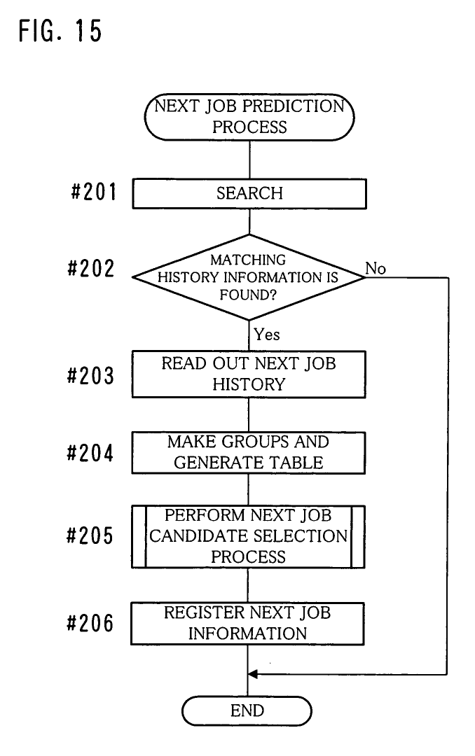

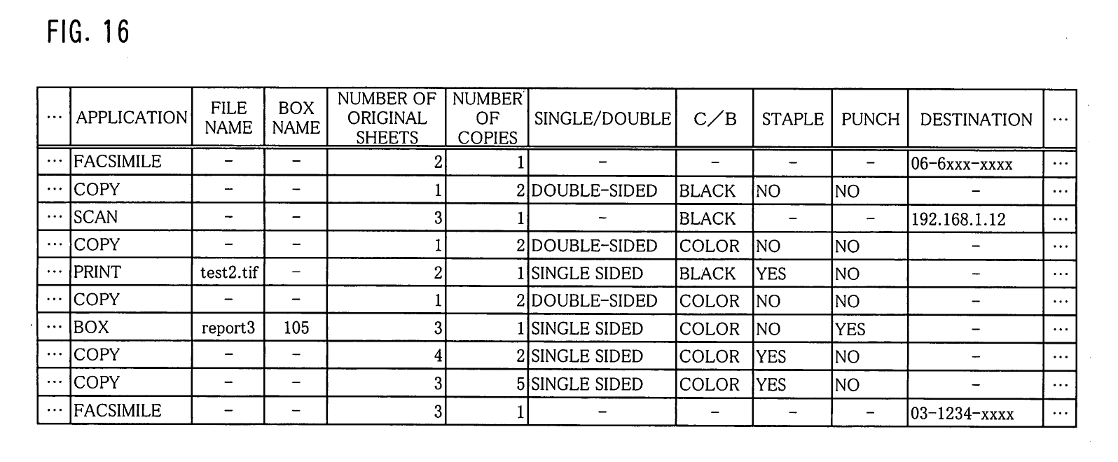

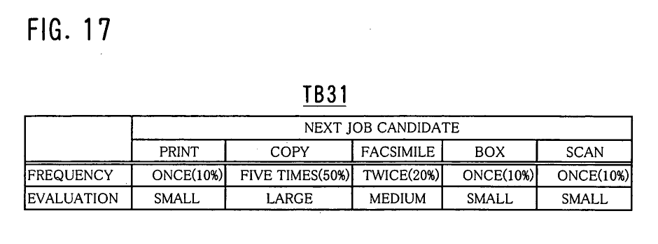

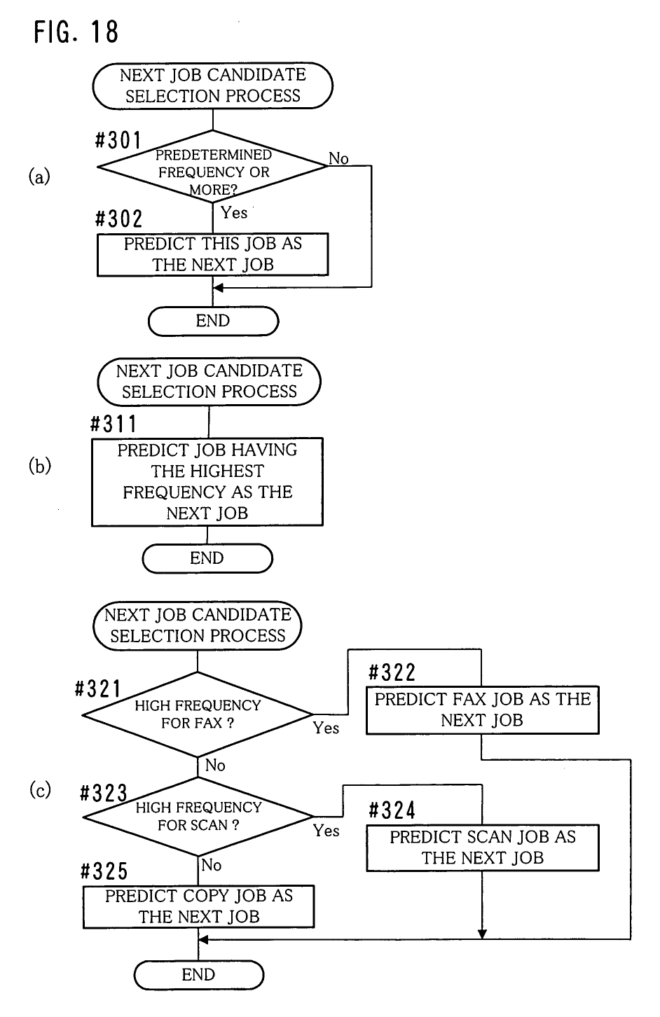

FIG. 14 is a flowchart showing an example of a flow of a general process of the image forming device 1 in the second embodiment, FIG. 15 is a flowchart showing an example of a flow of a next job prediction process, FIG. 16 is a diagram showing an example of a search result list of job history information 52, FIG. 17 is a diagram showing an example of a next job frequency table TB3, and FIGS. 18(a)-18(c) are flowcharts showing an example of a flow of a next job candidate selection process.

In the first embodiment, the next job of the user is predicted and a screen for designating the next job is displayed after the user logged in the image forming device 1 and performs the job once. In other words, the conventional menu screen HG0 as shown in FIG. 7 is displayed when the user logs in. In the second embodiment, a menu screen corresponding to the next job information 54 that is predicted in accordance with the user's last job information is displayed also when the user logs in.

The structure of the image forming device 1 in the second embodiment is the same as the case of the first embodiment as shown in FIGS. 2 and 4. However, there is a difference between timings of the display process of the screen in accordance with the next job information 54 by the general control portion 101 and the screen setting portion 105 shown in FIG. 4. Hereinafter, this difference will be mainly described with reference to the flowchart shown in FIG. 14. Description overlapping that of the first embodiment will be omitted.

In FIG. 14, the image forming device 1 performs user authentication of the user who intends to use the image forming device 1 so that the user logs in (Yes in #11 and #12) and checks whether or not the next job information 54 corresponding to the user ID of the user is registered (#13).

In the first embodiment, as described above with reference to the flowchart shown in FIG. 13, the image forming device 1 performs the job and then predicts a type and the like of the next job so that the next job information 54 indicating the prediction result is registered in the next job information registering portion 124 in association with the user ID of the user who instructed the job. Also in the second embodiment as being described later, the next job information 54 is registered after performing the job in the same manner as the case of the first embodiment. Therefore, if the user is a user who has once logged in the image forming device 1 for performing the job, the next job information 54 that is predicted in accordance with the last execution job information and is registered can be found. If the user is a user who uses the image forming device 1 for the first time, the next job information 54 cannot be found.

If the next job information 54 is found (Yes in #13), the next job information 54 is read out (#14). The general control portion 101 and the screen setting portion 105 shown in FIG. 4 perform setting of the screen in accordance with contents of the next job information 54 (a type and process conditions of the next job) and display the screen as shown in FIG. 11 or 12 (#15). However, if the user who logged in is a network user, the display process of the screen is performed by transmitting the screen data to the terminal device 2 of the user.

Here, the user presses the “START” button of the operation button unit 10f2 in the same way as the case of the first embodiment if the user wants to perform the job under the conditions as specified on the screen. It is possible to press the “START” button after changing process conditions by reselecting a button on the screen if necessary.

On the other hand, if the next job information 54 was not found (No in #14), the image forming device 1 displays the conventional menu screen HG0 in the state where specific process conditions are not designated as shown in FIG. 7, for example. Here, the user designates a type and process conditions of the desired job one by one in the conventional manner by pressing a button or a tab on the screen. Then, the user presses the “START” button.

When the “START” button is pressed (Yes in #16), a job is performed in accordance with the designation contents of the screen (#17), and the job history information 52 concerning the type and the process conditions of the job are registered in the job history table TB2 (see FIG. 8) (#18).

If the next job information 54 corresponding to the user ID of the user who instructed (i.e., the user who logged in) is already registered in the next job information registering portion 124, it is deleted temporarily (#19). The prediction process is performed for the next job that is a job probably desired by the user to be performed next in accordance with the type of the job performed this time (the execution job) and the job history information 52 that is already registered (stored) in the job history table TB2 (#20).

Although the prediction process can be performed in the procedure as shown in FIG. 9 in the same way as the case of the first embodiment, it is more preferable to perform in the procedure as described below with reference to FIG. 15.

The job history information 52 corresponding to a type of the execution job this time is searched from the job history table TB2 (#201). When the job history information 52 is found (Yes in #202), job history information 52 just after the job history information 52 is read out (#203). If plural sets of job history information 52 are found, job history information 52 just after each of the plural job history information 52 is read out. Then, types of the jobs indicated in the read job history information 52 are counted (#204), prediction of the next job is performed in accordance with the count result (#205), and the result is registered in the next job information registering portion 124 as the next job information 54 (#206).

The process contents shown in FIG. 15 will be described more in detail by concrete examples. For example, if the execution job this time is the box job, the job history information 52 indicating a file name that is the same as the file used for performing the box job, a box name of the box storing the file and a user ID of the user who made the instruction of the execution from the job history table TB2 in the step #201.

Job history information 52 just after the searched job history information 52 is read out of the job history table TB2 (#203). As a result, it is supposed that the job history information 52 as shown in the list of FIG. 16 is read out. Then, the image forming device 1 counts types of jobs indicated in these job history information 52, and the next job frequency table TB3 as shown in FIG. 17 is generated (#204). Note that “evaluation” in FIG. 17 means evaluation about frequency. If frequency of a job is more than or equal to predetermined frequency α, the evaluation “large” is given. If it is less than the predetermined frequency α and more than or equal to predetermined frequency β (here, α>β), the evaluation “medium” is given. If it is less than the predetermined frequency β, the evaluation “small” is given.

Then, the next job is predicted by selecting one of five job types in the next job frequency table TB3 (#205). The selection method can be changed in accordance with the type of the execution job this time, if necessary. For example, if the execution job this time is the box job, it is possible to select one having frequency higher than a predetermined value as a type of the next job as shown in FIG. 18(a). Alternatively, it is possible to select one having the highest frequency as shown in FIG. 18(b). It is possible to count and predict process conditions too.

Alternatively, if the execution job this time is the print job, each process shown in FIG. 15 is performed as follows. In the step #201, job history information 52 that indicates a file name that is the same as the file used for performing the print job and a user ID of the user who made the instruction of the execution from the job history table TB2.

Job history information 52 just after the searched job history information 52 is read out of the job history table TB2 (#203). Here, it is supposed that the job history information 52 of the same contents as the above-described example of the box job (see FIG. 16) is read out for simplifying description. The image forming device 1 counts types of jobs indicated in these job history information 52, so that the next job frequency table TB3 (see FIG. 17) is generated (#204).

Then, in the same manner as the above-described case of the box job, one of the five job types in the next job frequency table TB3 is selected for predicting the next job (#205). Although the above-described method shown in FIG. 18(a) or 18(b) can be used as the selection method, it is possible to use the method shown in FIG. 18(c). More specifically, if the evaluation of the fax job indicated in the next job frequency table TB3 is “large” (Yes in #321 in FIG. 18(c)), the fax job is selected as a type of the next job (#322). If the evaluation of the scan job is “large” (No in #321 and Yes in #323), the scan job is selected as a type of the next job (#324). If each of the evaluations of the fax job and the scan job is not “large” (No in #321 and No in #323), the copy job is selected as a type of the next job (#325). It is possible to count the job history information 52 of the read type and to predict process conditions of the next job too after predicting a type of the next job.

If the type of the execution job is other than the box job and the scan job, the next job is predicted in accordance with its characteristic. Note that it is possible to use the method shown in FIGS. 18(a)-18(c) in the first embodiment.

With reference to FIG. 14 again, the image forming device 1 performs setting of the screen in accordance with the newly registered next job information 54, i.e., the prediction result in the step #20 in the same manner as the case of the first embodiment corresponding to contents of the next job information 54 (a job type and process conditions), and it displays the screen as shown in FIG. 11 or 12 (#15). Then, the process in the steps #13-#20 is performed as appropriate. When the user finishes using the image forming device 1 and logs off (No in #16), the process shown in FIG. 14 is finished. Note that if plural next jobs are predicted in the step #20, the user may select which next job is desired so that the screen will be displayed in accordance with the selection result.

The display function of the menu screen in this embodiment is convenient in the following case. For example, it is convenient for a user who often performs an intermittent workflow including [Step 2-1] the image forming device 1 prints out a document created by a user using the terminal device 2 or a document stored in a box (network printing or PC printing), [Step 2-2] another person (for example, a user's supervisor) seals the paper of the printed document after logging out, and [Step 2-3] the image forming device 1 sends the paper to another fax terminal via fax after logging in again.

In the first and the second embodiments, as described with reference to the steps #101-#103 in FIG. 9(a), the steps #111-#113 in FIG. 9(b) and the steps #201-#203 in FIG. 15, job history information 52 indicating the same type as the execution job is searched, and job history information 52 stored in the job history table TB2 just after the job history information 52 is read out. Then, the prediction about the next job is performed in accordance with the read contents. In this case, the user indicated in the read job history information 52 may be different from the user who made the instruction of the execution job. In particular, if the image forming device 1 is working without a halt, there is high possibility of mismatch. Therefore, it is possible that the object of each searching process and reading process shown in FIGS. 9(a), 9(b) and 15 is limited only to the job history information 52 of the user who made the instruction of the execution job and that the job history information 52 indicating another user is neglected.

Furthermore, the structure of the entire or a part of the image forming device. 1, the process contents, the process order, the contents of the tables and the like can be modified in accordance with the spirit of the present invention if necessary.

The present invention can be used preferably in particular for improving ease of operation in an image processing device such as MFP that can perform various types of processes.

While example embodiments of the present invention have been shown and described, it will be understood that the present invention is not limited thereto, and that various changes and modifications may be made by those skilled in the art without departing from the scope of the invention as set forth in the appended claims and their equivalents.

What is claimed is:

1. An image processing device for performing an image-related process about an image, comprising:
a next process predicting portion for performing prediction of process contents of the image-related process that is probably designated by a user next after the image-related process of contents designated by the user was performed; and
a display processing portion for performing a display process for displaying a screen on which process contents of the predicted image-related process is set.

2. The image processing device according to claim 1, further comprising a history storage portion for storing history information that indicates the process contents every time when the image-related process is performed, wherein the next process predicting portion performs the prediction in accordance with the history information stored in the history storage portion.

3. The image processing device according to claim 2, wherein the next process predicting portion performs the prediction in accordance with next history information that was stored after history information that indicates process contents that are entirely or partially the same as process contents of the performed image-related process among the history information stored in the history storage portion.

4. The image processing device according to claim 2, wherein the history information indicates a type of the image-related process, and the next process predicting portion performs the prediction in accordance with history information that was stored after history information that indicates the same type as the performed image-related process among the history information stored in the history storage portion.

5. The image processing device according to claim 2, wherein the history information indicates a type of the image-related process and identification information of used data, and the next process predicting portion performs the prediction in accordance with history information that was stored after history information that indicates the same type as the performed image-related process and indicates identification information of data used in the performed image-related process among the history information stored in the history storage portion.

6. The image processing device according to claim 3, wherein the next process predicting portion performs the prediction by discriminating process contents that are most indicated in the next history information if a plurality of the next history information is stored in the history storage portion.

7. The image processing device according to claim 2, wherein the display processing portion performs the display process by displaying the screen on a display portion that is provided to the image processing device if a user directly operates an operation portion that is provided to the image processing device so as to designate process contents of the image-related process, and the display processing portion performs the display process by transmitting screen data for displaying the screen to another device if a user operates the other device that is connected via a network so as to designate process contents of the image-related process remotely.

8. The image processing device according to claim 2, further comprising a next process prediction storage portion for storing next process prediction information in association with the user, the next process prediction information indicating process contents of the image-related process that is probably designated by the user next, and the display processing portion performs the display process in accordance with latest next process prediction information corresponding to the user stored in the next process prediction storage portion when the user logs in the image processing device.

9. The image processing device according to claim 2, wherein the history information indicates a type of the image-related process, and the next process predicting portion performs the prediction in accordance with the next history information that was searched by using a searching method corresponding to the type of the performed image-related process.

10. The image processing device according to claim 1, further comprising
an input portion for entering user information of a user who intends to use the image processing device,
a user authentication portion for performing an authentication process for deciding whether the user is allowed to log in or not in accordance with the entered user information, and
a history storage portion for storing history information that indicates process contents of the image-related process every time when the process is performed, wherein
the next process predicting portion performs the prediction in accordance with the history information of the image-related process that was performed last time, the history information being stored in the history storage portion, and
the display processing portion performs the display process after the user logs in.

11. A method for displaying a screen on an image processing device for performing an image-related process about an image, the method comprising the steps of:
performing prediction of process contents of the image-related process that is probably designated by a user next after the image-related process of contents designated by the user was performed; and
performing a display process for displaying a screen on which process contents of the predicted image-related process is set.

12. The method according to claim 11, further comprising letting a history storage portion store history information that indicates process contents of the image-related process every time when the image-related process is performed, wherein the prediction is performed in accordance with the history information stored in the history storage portion.

13. The method according to claim 11, further comprising entering user information of a user who intends to use the image processing device, performing an authentication process for deciding whether the user is allowed to log in or not in accordance with the entered user information, and letting a history storage portion store history information that indicates process contents of the image-related process every time when the image-related process is performed, wherein the prediction is performed in accordance with the history information stored in the history storage portion after the user logs in.

14. The method according to claim 11, wherein the prediction is performed in accordance with history information that was stored after history information that indicates process contents that are entirely or partially the same as process contents of the performed image-related process among the history information stored in the history storage portion.

15. A computer program product for use in an image processing device that has a display portion for displaying a screen and performs an image-related process about an image, the computer program product makes the image processing device execute the processes comprising:
a prediction process for predicting process contents of the image-related process that is probably designated by a user next after the image-related process of contents designated by the user was performed; and
a display process for displaying a screen on which process contents of the predicted image-related process is set.

16. The computer program product according to claim 15, wherein the computer program product makes the image processing device execute the processes comprising
a process for storing history information that indicates process contents of the image-related process in a history storage portion every time when the image-related process is performed, and
the prediction process being performed in accordance with the history information stored in the history storage portion.

17. The computer program product according to claim 15, wherein the computer program product makes the image processing device execute the processes comprising:
a process for entering user information of a user who intends to use the image processing device,
an authentication process for deciding whether the user is allowed to log in or not in accordance with the entered user information,
a process for storing history information that indicates process contents of the image-related process every time when the process is performed, and
the prediction process being performed in accordance with the history information stored in the history storage portion after the user logs in.

18. The computer program product according to claim 15, wherein the computer program product makes the image processing device execute the prediction process in accordance with history information that was stored after history information that indicates process contents that are entirely or partially the same as process contents of the performed image-related process among the history information stored in the history storage portion.
